(19) United States
(12) Patent Application Publication
(10) Pub. No.: US 2024/0198880 A1
(43) Pub. Date: Jun. 20, 2024

(54) ALTERNATIVE WIDTH MASSAGE

(71) Applicant: Lear Corporation, Southfield, MI (US)

(72) Inventors: Samuel Blair, Troy, MI (US); Joshua Hallock, Warren, MI (US); David Abdella, Royal Oak, MI (US)

(21) Appl. No.: 18/085,120

(22) Filed: Dec. 20, 2022

(51) Int. Cl. B60N 2/90; B60N 2/00; B60N 2/66

(52) U.S. Cl. CPC B60N 2/976; B60N 2/002; B60N 2/665

(57) ABSTRACT

A massaging assembly for a seat such as a vehicle seat is disclosed. The massaging assembly includes a plurality of bladders arranged along one or more dimensions of an occupant and are configured to determine one or more dimensions of the occupant. For example, a controller cooperates with the plurality of bladders to perform a scan to determine the one or more dimensions. The controller subsequently performs massages via the plurality of bladders based on the one or more occupant dimensions.

### TECHNICAL FIELD

The present disclosure relates to massage assemblies and more specifically massage assemblies in vehicular seats.

### BACKGROUND

Seat assemblies and subassemblies are disclosed in U.S. Pat. No. 7,874,616 which issued to Lear Corporation on Jan. 25, 2011.

### BRIEF DESCRIPTION OF THE DRAWINGS

FIG. 1 is a partial cross-sectional side perspective view of a seat assembly.

FIG. 2 is a front view of a conventional fluid system for a seat assembly.

FIG. 3 is a front view of a first embodiment of a fluid system for a seat assembly.

FIG. 4 is a front view of a second embodiment of a fluid system for a seat assembly.

FIG. 5 is a front view of a larger occupant seated in a seat assembly with the second embodiment of the fluid system.

FIG. 6 is a front view of a smaller occupant seated in the seat assembly with the second embodiment of the fluid system.

FIG. 7 is a schematic of a seat assembly including a controller and a fluid system.

FIG. 8 is a flow chart of method of applying a massage.

FIG. 9 is a schematic of a valve actuator.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose implies the mixtures of any two or more of the members of the group or class are equally suitable or preferred. Molecular weights provided for any polymers refers to number average molecular weight. A description of constituents in chemical terms refers to the constituents at the time of addition to any combination specified in the description and does not necessarily preclude chemical interactions among the constituents of a mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” or “generally” may modify a value or relative characteristic disclosed or claimed in the present disclosure. In such instances, “substantially” or “generally” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

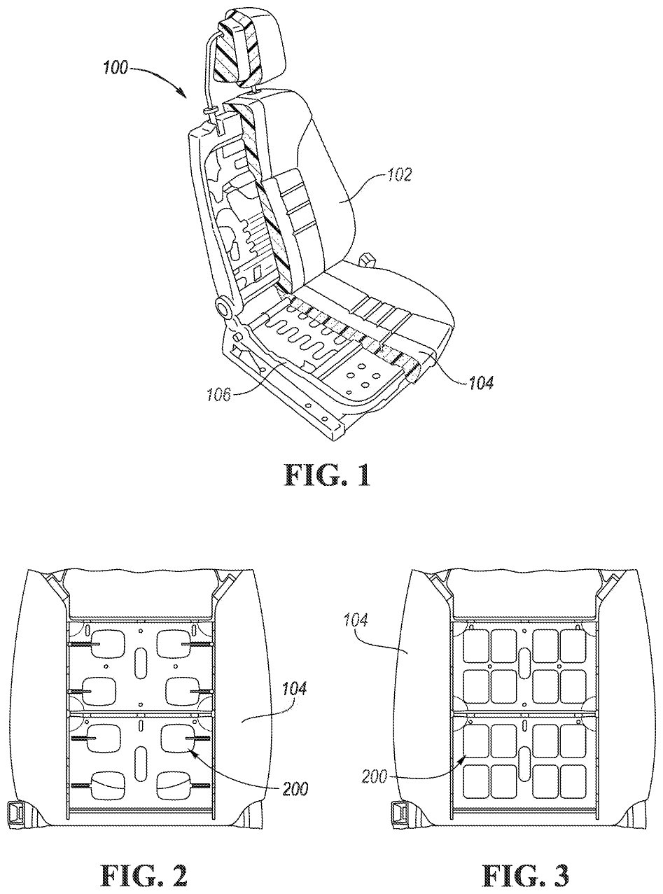

Referring to FIG. 1, a seat assembly 100 such as for a vehicle is provided. For example, the seat assembly 100 is used for a motorcycle, automobile, watercraft, aircraft, or train. In one or more embodiments, the seat assembly includes a trim cover 102 disposed over a cushion assembly 104, and a seat frame 106. As shown in FIGS. 2-4 and 5, the seat assembly 100 also includes a fluid system 200 such as for massaging and/or adjusting the seat.

In various embodiments, the fluid system 200 is disposed in, on, and/or adjacent to the cushion assembly 104. In a variation, the cushion assembly 104 includes a plurality of cushions. For example, the cushion assembly 104 includes a seat bottom and seat back each having a center or middle cushion which may be sandwiched between bolster cushions. In a refinement, the fluid system 200 is disposed in, on, and/or adjacent to one or more of the cushions. For example, as shown in FIGS. 2-6 the fluid system 200 is disposed in the seat back of the cushion assembly 104. In a refinement, the cushions of the cushion assembly 104 are foam and/or a plurality of polymeric strands.

In one or more embodiments, the fluid system 200 includes a fluid displacing device such as a pump, blower, compressor and/or fan. During operation the fluid displacing device moves the fluid or causes a fluid flow. In a variation, the fluid system 200 includes a first plurality of fluid bladders 202 arranged along a first direction and/or dimension and a second plurality of fluid bladders 204 arranged along a second direction and/or dimension such as, for example, X₁ and Y₁ respectively, as shown in FIG. 4. For example, the first direction and/or dimension is defined by a transverse axis and the second direction and/or dimension is defined by a longitudinal axis. In a refinement, the X₁ and Y₁ are different, not parallel, intersecting, and/or substantially orthogonal or perpendicular (e.g., defining an angle that is 15 to 165 degrees, or more preferably 45 to 135 degrees, or even more preferably 60 to 120 degrees, or still even more preferably 90 degrees). When the first and second plurality of bladders are arranged in this manner it employs a greater range and capacity for different size individuals, support, massage procedures, and/or configurations. In various embodiments, the bladders or each plurality of bladders includes 4 to 20 bladders, or more preferably 6 to 16 bladders, or even more preferably 8 to 12 bladders.

In yet another embodiment, a third plurality of bladders 206 and a fourth plurality of bladders 208 are arranged along a third direction and/or dimension (e.g., X₂) and a fourth direction and/or dimension (e.g., Y₂). In a refinement, X₂ is parallel or substantially parallel to X₁. (e.g., within 20% of parallel, or more preferably within 10% of parallel, or even more preferably within 5% of parallel). A greater number of bladders provides for greater customization to the size, shape, and comfort of different occupants. In another variation, the bladders are arranged in at least a 4×4 grid pattern, or more preferably at least a 4×6 grid pattern, or even more preferably at least 6×6 grid pattern corresponding to numerous groups of bladders along different dimensions, directions, and/or axes. In a refinement, the fluid system 200 includes at least 16 bladders, or more preferably at least 20 bladders, or even more preferably at least 24 bladders.

In some embodiments, a plurality of bladders such as the first/second/third/fourth plurality of bladders 202/204/206/208 is disposed within a specific region of the cushion assembly and may correspond to a region of an occupant (e.g., back, lower back, upper back, mid-back, bottom, thighs, left side, right side, center section, etc.). For example, the first plurality of bladders 202 (or third plurality of bladders 206) is disposed at a lower region 210 (or upper region 212) of, for example, the seat back corresponding to the lower (or upper) back of an occupant. In yet another example, the second plurality of bladders 204 (or fourth plurality of bladders 208) is disposed on a first side or half 214 (or second side or half 216) of the seat assembly 100. It should be understood, as shown in FIGS. 3-4, that multiple groups or pluralities of bladders may be disposed in the same region (e.g., lower back, upper back, left side, right side).

In one or more embodiments, the dimension upon which the plurality of bladders is disposed corresponds to an occupant dimension such as the width and/or height of the occupant (e.g., lower back dimension, shoulders dimension, neck dimension, thighs dimension, etc.). In a refinement, the dimension is greater than the 10^{th} percentile of an occupant dimensions, or more preferably greater than the average dimension of occupants, or even more preferably is a dimension in the 75^{th} percentile or greater of occupants, still more preferably is a dimension in the 85^{th} percentile or greater of occupants, or yet more preferably is a dimension in the 90^{th} percentile or greater of occupants.

For example, the dimension corresponds to a shoulder width such that the plurality of bladders extend along a dimension that corresponds to a shoulder width greater than the 10^{th} percentile of occupants, or more preferably greater than the average shoulder width of occupants, or even more preferably a shoulder width in the 75^{th} percentile of occupants or greater, or still more preferably a shoulder width in the 85^{th} percentile of occupants or greater, or yet more preferably a shoulder width in the 90^{th} percentile of occupants or greater.

In yet another variation, different groups of bladders in a plurality of bladders are arranged to accommodate various populations of occupants. For example, a first group of bladders (e.g., inner most columns of bladders including 208) corresponds to a population of occupants having a smaller dimension (e.g., shoulder width) than average, a second group of bladders (e.g., the inner most columns and second inner most columns of bladders including 208 and 204) corresponds to a second population of occupants having about an average dimension (e.g., shoulder width), and a third group of bladders (e.g., all columns of bladders) corresponds to a third population of occupants having a larger dimension (e.g., shoulder width) than average.

In one or more embodiments, the first plurality of bladders is arranged along a dimension, direction, or axis corresponding to the width, height, or length of the seat bottom or seat back and the second plurality of bladders is arranged along a different dimension, direction, or axis corresponding to the width, height, or length of the seat bottom or seat back.

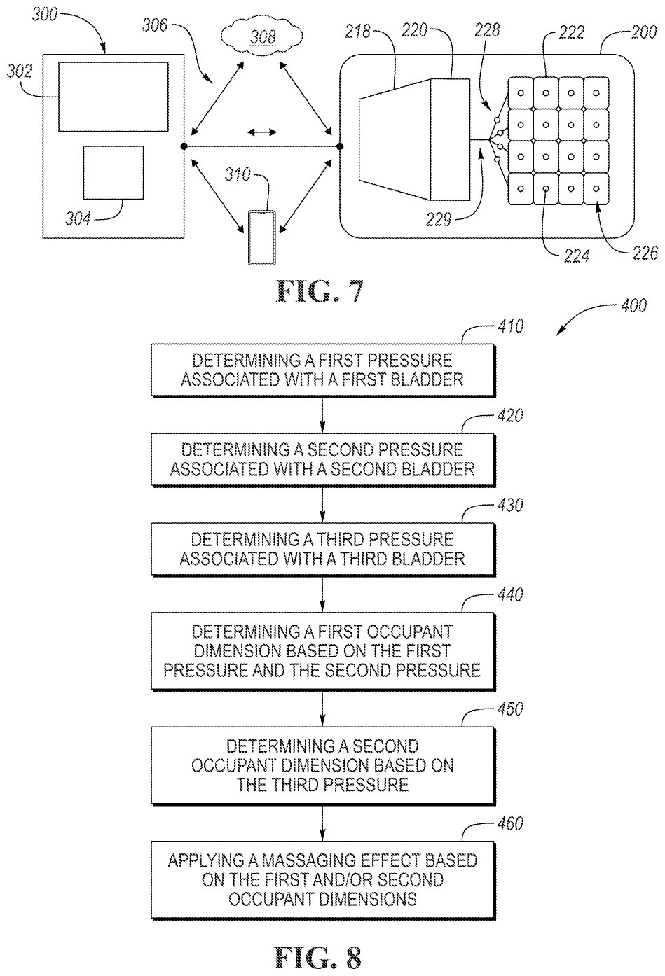

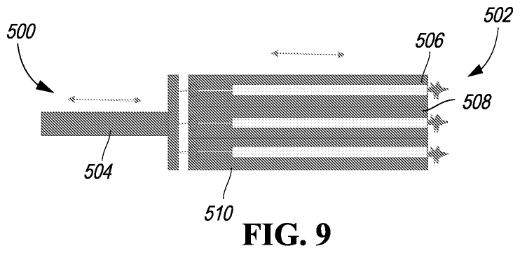

In still other embodiments, the seat assembly 100 include a controller 300 in cooperating and in communication with the fluid system 200, as shown in FIG. 7. In a variation, the controller 300 includes memory 302 and a processor 304. For example, the memory 302 stores computer executable code or instructions that are executed by the processor 304 to carry out the various functions described herein. In a refinement, the controller 300 cooperates with and is in communication with the fluid displacing device 218 and/or a valve assembly 220 such that fluid (e.g., air or water) displaced by the fluid displacing device 218 (e.g., compressor or pump) through the valve assembly 220 to fill/inflate or release/deflate one or more of the bladders 222. In one or more embodiments, an actuator such as a valve actuator 500, as shown in FIG. 9, cooperates with a plurality of valves 502 that open and close together. For example, the actuator head 504 opens and closes a first valve 506, a second valve 508, and a third valve 510. In various embodiments, the valve actuator 500 is used, for example, with the fluid system of FIG. 4, such that the first valve 506 services a large dimension (e.g., outer), the second valve 508 services a mid-dimension, and the third valve 510 services a small dimension (e.g., inner). Using valve actuators of this kind reduces cost while still providing efficient customization to occupants.

In a variation, the system 200 also includes one or more sensors 224 such as pressure sensors to detect a pressure associated with one or more of the bladders 222. In a refinement, the pressure is measured directly by a pressure sensor. In other embodiments, a proxy variable is used to detect the pressure. Sensors may additionally or alternatively be located in or proximate each bladder to detect a pressure associated with of that bladder. For example, a sensor is located in a position configured to detect a pressure associated with a group or a plurality of bladders. For instance, a sensor is located in a passage (e.g., supply and/or exhaust passages) associated with the first plurality of bladders and each corresponding plurality of bladders. In a refinement, the various plurality or groups of bladders may be filled/inflated, and the fluid is released through an exhaust passage such that a sensor in the exhaust passage determines a pressure associated with the plurality or group of bladders. In short, sensors are arranged in and/or proximate the bladders to determine pressures associated with respective bladders or groups of bladders. For example, an air pressure sensor such as a board mounted air pressure is used. In yet another example, the sensors measure stretch or pressure of the sheet. In still another example, a thin film and/or push-button type sensor is used. In some embodiments, a combination of sensors is used.

In one or more embodiments, the controller 300 cooperates with and is in communication with the one or more sensors 224. In a refinement, the controller 300 performs a scan to determine the size and/or dimensions of an occupant. In a variation, the scan is performed by filling/inflating one or more bladders, emptying/deflating the one or more bladders and detecting a (first) pressure associated with the one or more bladders. In various embodiments, the (first) pressure is indicative of the occupant's size or dimension. For example, if the occupant's dimension exceeds a threshold pressure it indicates the occupant is adjacent the one or more bladders.

In another or the same embodiment, if the (first) pressure is greater than a (second) pressure associated with one or more other bladders it indicates the occupant is adjacent the one or more bladders. For example, if a first pressure associated with an inner group of bladder is 2.00 PSI while an occupant is seated, any pressure that is less than a threshold amount relative to the inner group of bladders may indicate an occupant is not adjacent that group of bladders. In other words, a drop in pressure of at least 10%, or more preferably at least 25%, or even more preferably at least 50% indicates the occupant is not adjacent the group of bladders. For instance, a second pressure associated with an exterior group of bladders having a pressure of greater than 1.0 PSI, or more preferably greater than 1.5 PSI, or even more preferably greater than 1.8 PSI may indicate the occupant is adjacent the exterior group of bladders, i.e., the occupant's dimension extends to at least the exterior group of bladders. However, if the second pressure associated with the exterior group of bladders is 1.8 PSI or less, or more preferably 1.5 PSI or less, or even more preferably 1.0 PSI or less the occupant is not adjacent the exterior group of bladders, i.e., the occupant's dimension does not extend to the exterior group of occupants. In one or more embodiments, a pressure associated with each group, or every bladder is detected to determine the occupant's size or dimension. In another embodiment, the scan works inward by determining pressures associated with outer groups or bladders first. The scan progresses inward until an occupant's size or dimension is determined. In a refinement, the scan determines a pressure associated with a particular bladder or group such as the inner most group before working inward to establish a threshold pressure or reference pressure.

In the example above, the first (inner) group and second (outer) group are described for exemplary purposes. However, it should be understood that numerous groups are included in a scan and different groups may overlap or share bladders. For example, the inner and outer groups may refer to inner and outer columns along the back, but the scan may also include lower and upper groups of the back that include portions of the inner and outer groups to determine dimensions across an occupants back in two different directions (e.g., width and height).

In various embodiments, the scan determines numerous dimensions of an occupant. For example, in at least one embodiment, the scan determines a first dimension of an occupant such as corresponding to a shoulder width of the occupant and a second dimension such as corresponding to a lower back width of the occupant. Additionally, or alternatively, the scan determines a height dimension of the occupant's back.

In one or more embodiments, the controller 300 cooperates with and is in communication with the bladders 222, sensors 224, fluid displacing device 218, valve assembly 220, and/or a control unit 310 such as a mobile phone over a wired and/or wireless network 306. For example, the network 306 includes the internet 308. In various embodiments, different networks such as a wired and wireless network are used to communicate with different components. In a refinement, the control unit 310 is used to control the subassembly such as the massaging system 200. For example, an occupant can initiate a scan from the control unit 310, turn on or off a massaging unit, select specific conditions such as desire support and/or massaging procedures. Additionally, or alternatively, scanning is initiated automatically once an occupant is seated and the vehicle is in operation.

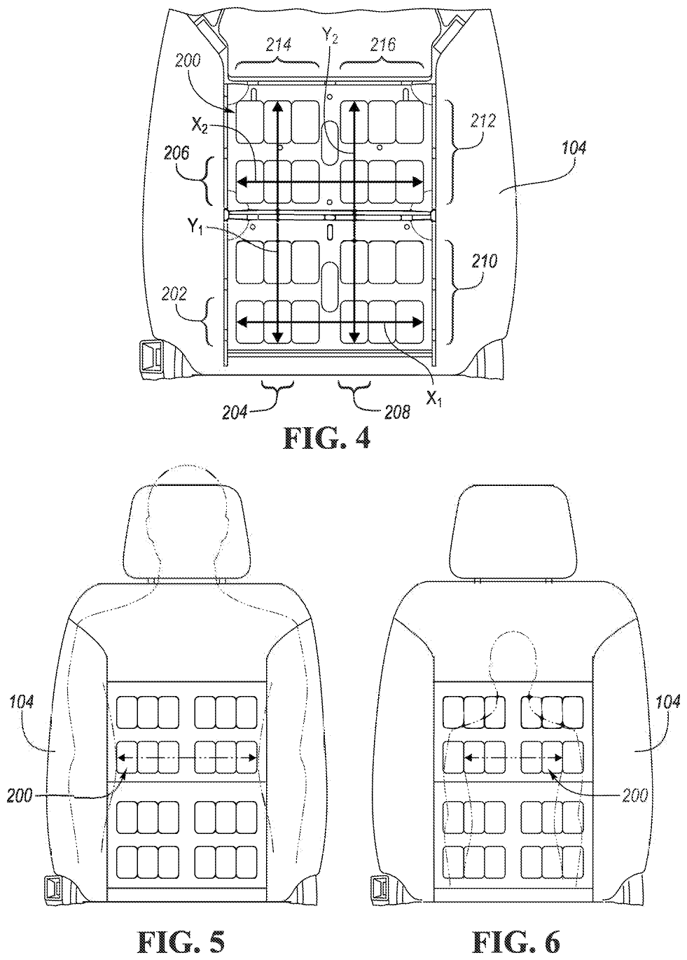

In various embodiments, after determining or acquiring one or more (e.g., one, two, three, four, five, etc.) occupant dimensions, the controller 300 uses the occupant dimension(s) to perform custom task such as providing support and/or massaging protocols. For example, the system 200 employs a massage using all 24 bladders given the occupants size in FIG. 5 but may only use 16 bladders to massage the occupant of FIG. 6. In other words, the controller 300 employs a massage that does not use the exterior columns of bladders given the occupants dimensions do not extend beyond those bladders. In a refinement, this selectivity provides a more comfortable and custom massage. Energy is also not wasted on bladders that are not in contact with the occupant.

In yet another embodiment, the scan detects “hot spots” or one or more points where an unusual or high amount of pressure is applied by an occupant. In various embodiments, the support or massage employed thereafter by the controller 300 is targeted or directed to the one or more points. For example, additional support is provided in other regions to alleviate the pressure in the hot spots. In one or more embodiments, the bladders are used to provide support as well as massaging effects. In such embodiments, the amount of support, i.e., pressure of the bladders corresponds to the amount of pressure exerted upon the bladders or groups of bladders by the occupant as determined by the scan.

In one or more embodiments, the controller 300 cooperates with and is in communication with fluid passages 228, 229, the fluid displacing device 218, the valve assembly 220 and one or more bladders 222 such that the bladders can be filled/inflated individually or simulated such that one or more scans can be performed as well as different massaging functions. For example, the scan includes filing various columns and rows of bladders to determine an occupant dimension but after determining an occupant's dimension individual bladders may be filled to provide a massage effect such as a shiatsu effect within the dimensions.

Various massaging effects are known including shiatsu, Swedish, deep tissue, trigger point and others as well as various techniques for simulating such massages. For example, a shiatsu massage effect is provided by filling/inflating a bladder to a pressure such that it pushes into the occupant and then relieving the bladder to mitigate the pressure. This may be repeated numerous times and at different locations to simulate pressure from hands and/or fingers being applied to the occupant. Regardless, a massaging effect refers to applying and alleviating pressure by filling/inflating and releasing/deflating one or more bladders. As described above, the massaging effect is based on the occupant's dimensions. For example, bladders outside or extending beyond the occupant's dimension(s) are excluded from massages or support procedures. In other words, pressure changes within the bladders are within the bounds of the occupant's dimensions.

In various embodiments, the seat frame 106 is any suitable material to support the subassemblies and an occupant. In a variation, the seat frame 106 includes a rigid material such as metal, plastic, wood, or a combination thereof. For example, a steel and/or aluminum seat frame 106 is used. The cushion assembly 104 includes one or more cushions. In various embodiments, the trim cover 102 is configured to be adjacent a seated occupant, i.e., the trim cover 102 includes the outermost layer defining an outermost surface. In a variation, the trim cover 102 is disposed over one or more subassemblies, as shown in FIGS. 2-6. In a refinement, the trim cover 102 includes a fabric, woven fabric, faux leather, or leather surface. For example, trim cover 102 includes cotton, polyester, polyurethane, nylon, or any other suitable material.

As stated above, the system includes computer executable code or instructions which, in various embodiments, is stored on a non-transitory computer readable medium on local device or in the cloud via the network 306. A non-transitory computer readable medium having computer readable instructions configured to be executed by a processor provides for carrying out various functions for operation of the systems and seat assembly 100 such as actuating the fluid-displacing device and determining a pressure associated with one or more bladders via the sensors. A sensor may be used to measure the pressure directly or a proxy parameter for determining the pressure may be used. For example, a force (upon on known area) may be measured to determine the pressure.

In one or more embodiments, the processor includes one or more devices selected from high-performance computing systems including high-performance cores, microprocessors, micro-controllers, digital signal processors, microcomputers, central processing units, field programmable gate arrays, programmable logic devices, state machines, logic circuits, analog circuits, digital circuits, or any other device that manipulate signals (analog or digital) based on computer-executable instructions residing in the memory. In variations, the memory includes a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. In a refinement, the non-volatile memory/storage includes one or more persistent data storage devices such as a hard drive, optical drive, tape drive, non-volatile solid state device, cloud storage or any other device capable of persistently storing information.

In one or more embodiment, the executable code/instructions may reside in a software module. In a refinement, the software module includes operating systems and applications. In various embodiments, the software module is compiled or interpreted from a computer program created using a variety of programming languages and/or technologies, including, without limitation, and either alone or in combination, Java, C, C++, C #, Objective C, Fortran, Pascal, Java Script, Python, Perl, and PL/SQL. Non-volatile storage may also include data supporting the functions, features, calculations, and processes.

In some embodiments, the systems described above include computer readable storage media, which is inherently non-transitory, and in various refinements includes volatile or non-volatile, and removable and non-removeable tangible media implemented in any method or technology for storage of information, such as computer-readable instructions, data structures, program modules, or other data. In a variation, computer readable storage media further includes RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. In various embodiments, the computer readable program instructions may be downloaded to a computer, another type of programmable data processing apparatus, or another device form of a computer readable storage medium or to an external computer or external storage device via a network.

In one or more embodiments, the computer readable program instructions stored in a computer readable medium may be used to direct a computer, other types of programmable data processing apparatus, or other devices to function in a particular manner, such that the instructions stored in the computer readable medium produce an article of manufacture including instructions that implement functions, acts, and/or operations described herein. The functions, acts, and/or operations described herein may be re-ordered, processed serially, and/or processed concurrently.

Referring to FIG. 8 a method 400 of scanning and/or applying a massage is also disclosed. In one or more embodiments, the method 400 includes determining a first pressure 410 and a second pressure 420 respectively associated a first bladder and a second bladder, and determining a first occupant dimension based on the first and/or second pressures 440. For example, a sensor detects or measures the pressure associated with the bladders. The first and second pressures are compared to each other or to a threshold pressure to determine the first occupant dimension. In a refinement, the method 400 includes determining a third pressure associated with a third bladder 430. In various embodiments, the method 400 includes determining a second occupant dimension based on the third pressure 450. In a variation, the third pressure is compared the first and/or second pressures or a threshold pressure to determine the second occupant dimension. The method also includes applying a massage or massaging effect based on the first and/or second occupant dimensions. For example, the massage or massaging effect utilizes bladders that extend within the occupant dimension(s) but not bladders extending beyond or outside the occupant dimension(s).

According to a first aspect of the assemblies described herein, the assembly includes a first plurality of bladders arranged along a direction and a controller cooperating with the first plurality of bladders. The controller is configured to scan an occupant by filing one or more bladders of the plurality of bladders with a fluid and determining an associated pressure.

According to a second aspect, the scan of the first aspect or any of the following aspects is configured to determine a first dimension of an occupant.

According to a third aspect, the controller of any of the prior or subsequent aspects is configured to control the first plurality of bladders to massage an occupant according to the first dimension.

According to a fourth aspect, the scan of any of the prior or subsequent aspects includes filling each bladder and determining a corresponding pressure.

According to a fifth aspect, the scan of any of the prior or subsequent aspects includes filling a first group of bladders of the first plurality of bladders and determining a first pressure corresponding to the first group as well as filling a second group of bladders of the first plurality of bladders that is different than the first group of bladders and determining a second pressure corresponding to the second group.

According to a sixth aspect, the assembly of any of the prior or subsequent aspects includes one or more sensors corresponding to each bladder of the first plurality of bladders.

According to a seventh aspect, the assembly of any of the prior or subsequent aspects includes one or more sensors disposed in an exhaust pathway of the first plurality of bladders and the one or more sensors is configured to determine pressure associated with the first plurality of bladders such as a pressure of the fluid released from the first plurality of bladders.

According to an eighth aspect, the assembly of any of the prior or subsequent aspects includes a frame supporting the cushion and/or massage assembly.

According to a ninth aspect, the assembly of any of the prior or subsequent aspects includes a first plurality of bladders arranged along a first axis, a second plurality of bladders arranged along a second axis, and one or more sensors. Each bladder of the first plurality of bladders is configured to be filled with a fluid, individually or filled simultaneously and each bladder of the second plurality of bladders is configured to be filled with a fluid, individually or filled simultaneously. The one or more sensors are arranged to determine pressures associated with different groups of the bladders.

According to a tenth aspect, the assembly of any of the prior or subsequent aspects includes a seat back having a frame. The frame may support the massaging or fluid assemblies described herein.

According to an eleventh aspect, the first plurality of bladders of any of the prior or subsequent aspects is arranged along a width of a seat back at a first position

According to a twelfth aspect, the second plurality of bladders of any of the prior or subsequent aspects is arranged along the width of the seat back at a second position that is different than the first position.

According to a thirteenth aspect, the first plurality of bladders of any of the prior or subsequent aspects is arranged along a width of the seat back.

According to a fourteenth aspect, the second plurality of bladders of any of the prior or subsequent aspects is arranged along a height of the seat back.

According to a fifteenth aspect, the first plurality of bladders of any of the prior or subsequent aspects (except the eleventh and thirteenth aspects) is arranged along a height of the seat back at a first position.

According to a sixteenth aspect, the second plurality of bladders of any of the prior or subsequent aspects (except the twelfth aspect) is arranged along the height of the seat back at second position that is different than the first position.

According to a seventeenth aspect, the assembly of any of the prior or subsequent aspects includes a controller that cooperates with the first plurality of bladders. The controller being configured to scan an occupant by filling one or more bladders with a fluid and determining an associated pressure.

According to an eighteenth aspect, the scan of any of the prior or subsequent aspects is configured to determine one or more dimensions of an occupant.

According to a nineteenth aspect, a method including determining a first pressure associated with a first bladder, determining a second pressure associated with a second bladder, determining a first occupant dimension based on the first and second pressures.

According to a twentieth aspect, the pressure of any of the prior or subsequent aspects is determined by releasing the fluid from a bladder (e.g., the first and/or second bladder).

According to a twenty-first aspect, the assembly or method of any of the prior or subsequent aspects applies a massaging effect to an occupant based on the first occupant dimension.

According to a twenty-second aspect, the assembly or method of any of the prior or subsequent aspects includes determining a third pressure associated with a third bladder and determining a second occupant dimension based on the third pressure and the first and/or second pressure.

According to a twenty-third aspect, the assembly or method of any of the prior or subsequent aspects includes applying a massaging effect to an occupant based on the first and second occupant dimensions.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An assembly comprising:
a first plurality of bladders arranged along a direction; and
a controller cooperating with the first plurality of bladders, the controller configured to scan an occupant by filling one or more bladders with a fluid and determining an associated pressure.

2. The assembly of claim 1, wherein the scan is configured to determine a first dimension of an occupant.

3. The assembly of claim 2, wherein the controller is configured to control the first plurality of bladders to massage an occupant according to the first dimension.

4. The assembly of claim 1, wherein the scan includes filling each bladder and determining a corresponding pressure.

5. The assembly of claim 1, wherein the scan further comprises:
filling a first group of bladders of the first plurality of bladders and determining a first pressure corresponding to the first group; and
filling a second group of bladders of the first plurality of bladders that is different than the first group of bladders and determining a second pressure corresponding to the second group.

6. The assembly of claim 1, further comprising one or more sensors corresponding to each bladder of the first plurality of bladders.

7. The assembly of claim 1, further comprising one or more sensors disposed in an exhaust pathway of the first plurality of bladders, the one or more sensors configured to determine a pressure of the fluid released from the first plurality of bladders.

8. A seat assembly comprising a frame supporting the assembly of claim 1.

9. An assembly comprising:
a first plurality of bladders arranged along a first axis, each bladder of the first plurality of bladders configured to be filled with a fluid, individually or filled simultaneously;
a second plurality of bladders arranged along a second axis, the second axis different than the first axis, each bladder of the second plurality of bladders configured to be filled with the fluid individually or filled simultaneously; and
one or more sensors arranged to determine pressures associated with different groups of the bladders.

10. A seat back comprising a frame supporting the assembly of claim 9.

11. The seat back of claim 10, wherein the first plurality of bladders is arranged along a width of the seat back at a first position and the second plurality of bladders is arranged along the width of the seat back at a second position that is different than the first position.

12. The seat back of claim 10, wherein the first plurality of bladders is arranged along a width of the seat back and the second plurality of bladders is arranged along a height of the seat back.

13. The seat back of claim 10, wherein the first plurality of bladders is arranged along a height of the seat back at a first position and the second plurality of bladders is arranged along the height of the seat back at second position that is different than the first position.

14. The assembly of claim 9, further comprising a controller cooperating with the first plurality of bladders, the controller configured to scan an occupant by filling one or more bladders with a fluid and determining an associated pressure.

15. The assembly of claim 14, wherein the scan is configured to determine one or more dimensions of an occupant

16. A method comprising:
determining a first pressure associated a first bladder;
determining a second pressure associated with a second bladder;
determining a first occupant dimension based on the first and second pressures.

17. The method of claim 16, wherein first and second pressures are determined by releasing the fluid from the first and second bladders.

18. The method of claim 16, further comprising applying a massaging effect to an occupant based on the first occupant dimension.

19. The method of claim 16, further comprising determining a third pressure associated with a third bladder and determining a second occupant dimension based on the third pressure and the first and/or second pressures.

20. The method of claim 19, further comprising applying a massaging effect to an occupant based on the first and second occupant dimensions.
